(19) United States
(12) Patent Application Publication
(10) Pub. No.: US 2024/0046715 A1
(43) Pub. Date: Feb. 8, 2024

(54) DATA DRIVEN IDENTIFICATION OF A ROOT CAUSE OF A MALFUNCTION

(71) Applicant: GM GLOBAL TECHNOLOGY OPERATIONS LLC, DETROIT, MI (US)

(72) Inventors: Rasoul Salehi, Ann Arbor, MI (US); Sunil Prasanth Suseelan, Rochester Hills, MI (US); Shiming Duan, Ann Arbor, MI (US)

(21) Appl. No.: 17/881,838

(22) Filed: Aug. 5, 2022

(51) Int. Cl. G07C 5/08

(52) U.S. Cl. CPC G07C 5/0816; G07C 5/0808

(57) ABSTRACT

A method of diagnosing a malfunction includes receiving a signal from a component of a vehicle system, the received signal indicative of a symptom of a malfunction in the vehicle system, and acquiring a set of test signals. The method also includes comparing the received signal to each test signal to determine at least one observability distribution, the observability distribution including an observability value for each test signal, and determining a failure mode corresponding to the received signal based on the observability distribution. The determined failure mode represents a root cause of the symptom.

### INTRODUCTION

The subject disclosure relates to fault or failure detection, and more particularly to diagnosis of root causes of anomalous signals from complex systems.

Many modern vehicles (e.g., cars, motorcycles, boats, or any other types of automobile) include control systems that represent a complex integration of hardware and software components. Such control systems utilize information from many sources (e.g., sensors and control units) to monitor and control vehicle operations. In some cases, it can be difficult to readily identify the most relevant cause or causes of anomalous signals. As a result, troubleshooting these control systems requires deep understanding and time consuming analysis. Accordingly, it is desirable to provide a system that can improve diagnosis of vehicle (or other system) malfunctions and reduce the time and cost of diagnostic methods.

### SUMMARY

In one exemplary embodiment, a method of diagnosing a malfunction includes receiving a signal from a component of a vehicle system, the received signal indicative of a symptom of a malfunction in the vehicle system, and acquiring a set of test signals. The method also includes comparing the received signal to each test signal to determine at least one observability distribution, the observability distribution including an observability value for each test signal, and determining a failure mode corresponding to the received signal based on the observability distribution. The determined failure mode represents a root cause of the symptom.

In addition to one or more of the features described herein, each test signal is acquired from one or more components that are different than the component associated with the received signal.

In addition to one or more of the features described herein, the comparing includes determining a plurality of observability distributions.

In addition to one or more of the features described herein, an observability distribution is determined by applying a classification function to the received signal, generating a first label for the received signal, applying the first label to each test signal to generate labeled test signals, the first label classifying each test signal into one of a plurality of classes, training a classifier using selected data from each class, generating a predicted label for each test signal by applying the trained classifier to each test signal, and calculating an observability value for each test signal based on a comparison of the first labels to the predicted labels.

In addition to one or more of the features described herein, calculating the observability value includes calculating a deviation metric based on the comparison.

In addition to one or more of the features described herein, determining the failure mode includes inputting the received signal and the observability distributions to an inference algorithm, and estimating a probability of each observability distribution corresponding to the root cause.

In addition to one or more of the features described herein, determining the failure mode includes selecting a potential failure mode associated with an observability distribution having a highest probability as the root cause.

In addition to one or more of the features described herein, the inference algorithm includes a Bayesian classifier.

In addition to one or more of the features described herein, acquiring the set of test signals includes acquiring a plurality of additional signals in addition to the received signal, comparing each additional signal to fleet data indicative of normal vehicle system function, determining an anomaly index for each additional signal, and selecting the set of test signals from the plurality of additional signals based on the anomaly indexes.

In another exemplary embodiment, a system for diagnosing a malfunction includes a signal processing module configured to receive a signal from a component of a vehicle system, the received signal indicative of a symptom of a malfunction in the vehicle system, acquire a set of test signals, and compare the received signal to each test signal to determine at least one observability distribution, the observability distribution including an observability value for each test signal. The system also includes an identification module configured to determine a failure mode corresponding to the received signal based on the observability distribution, the determined failure mode representing a root cause of the symptom.

In addition to one or more of the features described herein, the signal processing module is configured to determine a plurality of observability distributions, and output the received signal and the plurality of the observability distributions to the identification module.

In addition to one or more of the features described herein, an observability distribution is determined by applying a classification function to the received signal, generating a first label for the received signal, applying the first label to each test signal to generate labeled test signals, the first label classifying each test signal into one of a plurality of classes, training a classifier using selected data from each class, generating a predicted label for each test signal by applying the trained classifier to each test signal, and calculating an observability value for each test signal based on a comparison of the first labels to the predicted labels.

In addition to one or more of the features described herein, the identification module includes an inference algorithm configured to estimate a probability of each observability distribution corresponding to the root cause.

In addition to one or more of the features described herein, the identification module is configured to determine the failure mode by selecting a potential failure mode associated with an observability distribution having a highest probability as the root cause.

In addition to one or more of the features described herein, the signal processing module includes a multi-layer architecture including a first layer configured to acquire the set of test signals, and a second layer configured to determine the at least one observability distribution.

In addition to one or more of the features described herein, the first layer is configured to receive a plurality of additional signals in addition to the received signal, compare each additional signal to fleet data indicative of normal vehicle system function, determine an anomaly index for each additional signal, and select the set of test signals from the plurality of additional signals based on the anomaly indexes.

In yet another exemplary embodiment, a vehicle system includes a memory having computer readable instructions, and a processing device for executing the computer readable instructions, the computer readable instructions controlling the processing device to perform a method. The method includes receiving a signal from a component of a vehicle system, the received signal indicative of a symptom of a malfunction in the vehicle system, acquiring a set of test signals, and comparing the received signal to each test signal to determine at least one observability distribution, the observability distribution including an observability value for each test signal. The method also includes determining a failure mode corresponding to the received signal based on the observability distribution, the determined failure mode representing a root cause of the symptom.

In addition to one or more of the features described herein, the comparing includes determining a plurality of observability distributions.

In addition to one or more of the features described herein, an observability distribution is determined by applying a classification function to the received signal, generating a first label for the received signal, applying the first label to each test signal to generate labeled test signals, the first label classifying each test signal into one of a plurality of classes, training a classifier using selected data from each class, generating a predicted label for each test signal by applying the trained classifier to each test signal, and calculating an observability value for each test signal based on a comparison of the first labels to the predicted labels.

In addition to one or more of the features described herein, determining the failure mode includes inputting the received signal and the observability distributions to an inference algorithm, estimating a probability of each observability distribution corresponding to the root cause, and selecting a potential failure mode associated with an observability distribution having a highest probability as the root cause.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is a top view of a motor vehicle including various processing devices, in accordance with an exemplary embodiment;

FIG. 2 depicts an example of a fuel system of the vehicle of FIG. 1;

FIG. 3 depicts a diagnostic system including a multi-layer symptom tracing architecture and an identification module, in accordance with an exemplary embodiment;

FIG. 4 depicts a first layer of the architecture of FIG. 3, in accordance with an exemplary embodiment;

FIG. 5 depicts an example of a list of test signals generated by the first layer, sorted based on an anomaly index generated for each signal;

FIG. 6 depicts a second layer of the architecture of FIG. 3, in accordance with an exemplary embodiment;

FIG. 7 is a flow diagram depicting aspects of a method of generating an observability index and/or observability distribution, in accordance with an exemplary embodiment;

FIG. 8 depicts the identification module of FIG. 3, the identification module configured as an inference engine, in accordance with an exemplary embodiment;

FIG. 9 depicts an example of labeled symptom data;

FIG. 10 depicts an example of labeled test data for a test signal;

FIG. 11 depicts an example of an observability distribution generated by the system of FIG. 3 for a first failure mode;

FIG. 12 depicts an example of labeled symptom data;

FIG. 13 depicts an example of labeled test data for a test signal;

FIG. 14 depicts an example of an observability distribution generated by the system of FIG. 3 for a second failure mode; and

FIG. 15 depicts a computer system, in accordance with an exemplary embodiment.

### DETAILED DESCRIPTION

The following description is merely exemplary in nature and is not intended to limit the present disclosure, its application or uses. It should be understood that throughout the drawings, corresponding reference numerals indicate like or corresponding parts and features.

Devices, systems and methods are provided for diagnosing system malfunctions based on symptom data and additional data to identify or determine a root cause or root causes of the malfunctions. Embodiments utilize an explainable data driven diagnostics methodology that assists detection of a hidden root cause (most significant or impactful cause) based on a symptom observed in a system. The system may be a large-scale system, such as a vehicle system, which can have a large number of complex operations, or a vehicle fleet. In an embodiment, the system uses a multi-layer symptom tracing architecture to detect signals with high-value information about potential root causes. The diagnostically important signals and their associated symptom observability metrics may then be used in a processing module that utilizes an inference algorithm (or other algorithm or algorithms) to detect a root cause or root failure mode causing the symptom.

Embodiments described herein present numerous advantages and technical effects. In complex systems such as vehicle systems, there is often a potentially large number of potential causes of a malfunction. As a result, identification of the actual root cause of the malfunction can be difficult and time consuming. The embodiments provide an efficient and explainable (human users can comprehend the detection process and trust the results) system for automatically detecting root causes and/or providing root cause information to a user. The embodiments reduce both the time and complexity associated with diagnostics.

The root cause of a malfunction can be hidden, at least because an anomalous signal from a sensor or other component may be a result of different faults or failure modes. Currently, troubleshooting such control systems requires deep understanding and manual analysis of many signals to detect the real root cause. Embodiments described herein address this problem by automating, streamlining and simplifying the process of diagnosing system malfunctions.

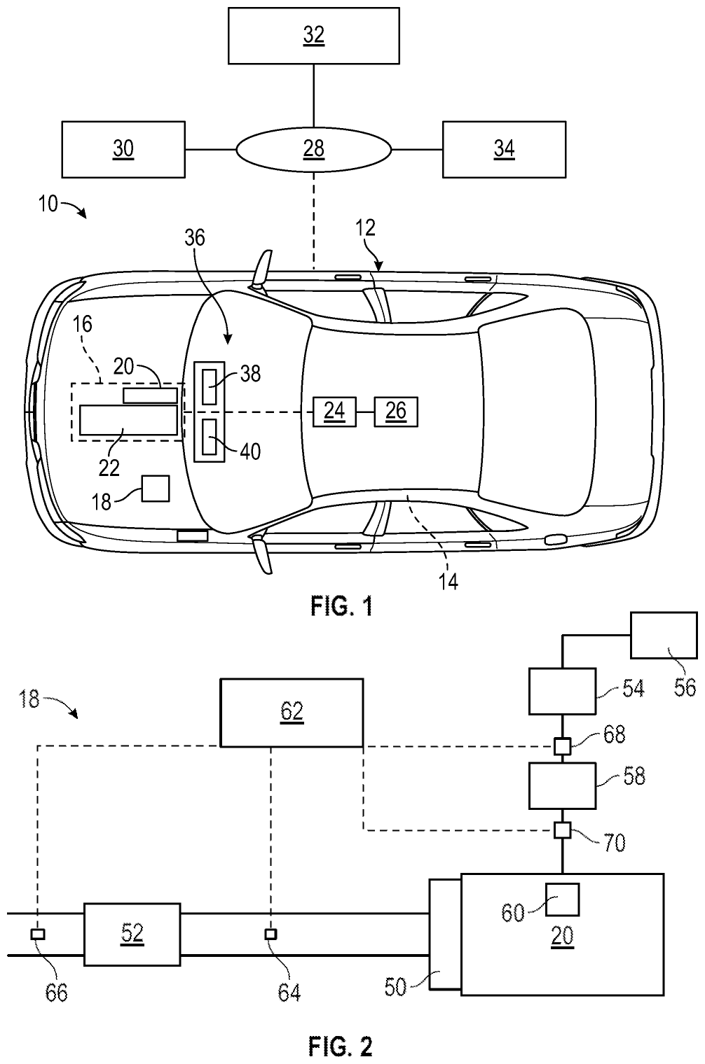

FIG. 1 shows an embodiment of a motor vehicle 10, which includes a vehicle body 12 defining, at least in part, an occupant compartment 14. The vehicle body 12 also supports various vehicle subsystems including a propulsion system 16, and other subsystems to support functions of the propulsion system 16 and other vehicle components, such as a fuel system 18, a braking system, a suspension system, a steering subsystem, an exhaust system and others.

The vehicle may be a combustion engine vehicle, an electrically powered vehicle (EV) or a hybrid vehicle. In an example, the vehicle 10 is a hybrid vehicle that includes a combustion engine 20 and an electric motor 22.

The vehicle also includes various control systems for controlling aspects of vehicle systems. For example, one or more electronic control units (ECUs) 24 are provided. Aspects of the diagnostic and control methods described herein may be performed by any suitable controller or processing device, such as the ECU 24 and/or controllers in respective subsystems.

An embodiment of the vehicle 10 includes devices and/or systems for communicating with other vehicles and/or objects external to the vehicle. For example, the vehicle 10 includes a communication system having a telematics unit 26 or other suitable device including an antenna or other transmitter/receiver for communicating with a network 28.

The network 28 represents any one or a combination of different types of suitable communications networks, such as public networks (e.g., the Internet), private networks, wireless networks, cellular networks, or any other suitable private and/or public networks. Further, the network 28 can have any suitable communication range associated therewith and may include, for example, global networks (e.g., the Internet), metropolitan area networks (MANs), wide area networks (WANs), local area networks (LANs), or personal area networks (PANs). The network 28 can communicate via any suitable communication modality, such as short range wireless, radio frequency, satellite communication, or any combination thereof

In an embodiment, the network 28 connects the vehicle 10 for communication with various entities. For example, the network 28 may be connected to other vehicles 30 in a vehicle fleet, databases 32 and/or other remote entities 34 such as workstations, control centers and others.

The vehicle 10 also includes a computer system 36 that includes one or more processing devices 38 and a user interface 40. The various processing devices and units may communicate with one another via a communication device or system, such as a controller area network (CAN) or transmission control protocol (TCP) bus.

FIG. 2 depicts an example of the fuel system 18, which can be monitored and diagnosed using systems and methods described herein. The fuel system 18 is described for illustration purposes and is not intended to limit the application of the embodiments described herein, as the embodiments can be applied to any vehicle component or system, or other complex system (e.g., manufacturing equipment).

The fuel system 18 includes hardware and control systems responsible for fuel storage and fuel delivery into an engine cylinder/manifold. The fuel system 18 includes an intake manifold 50 connected to the engine 20. Air is drawn through a throttle body 52, and mixed with fuel to form a fuel/air mixture that is combusted in the engine 20. The fuel system 18 also includes a low pressure (LP) pump 54 that receives fuel from a fuel tank 56 and provides the fuel at a first rail pressure. A high pressure (HP) pump 58 receives fuel from the LP pump 54 and provides fuel at a second rail pressure that is higher than the first rail pressure. Fuel is injected via a fuel injector or injectors 60

The fuel system 18 includes various sensors for monitoring and control, which are connected to a controller 62 (e.g., a fuel controller or engine control module (ECM)). The controller 62 may be a single controller or multiple controllers for controlling different aspects of the fuel system 18 and/or the engine 20. For example, the fuel system 18 includes an intake air temperature (IAT) sensor 64, a mass air flow (MAF) sensor 66, and pressure sensors such as a pressure sensor 68 for measuring the first rail pressure and a pressure sensor 70 for measuring the second rail pressure. Signals from each sensor are transmitted to the controller 62.

Embodiments are discussed in conjunction with the fuel system 18 and the controller 62. However, the embodiments are not so limited and may be performed by any suitable processing device or combination of processing devices.

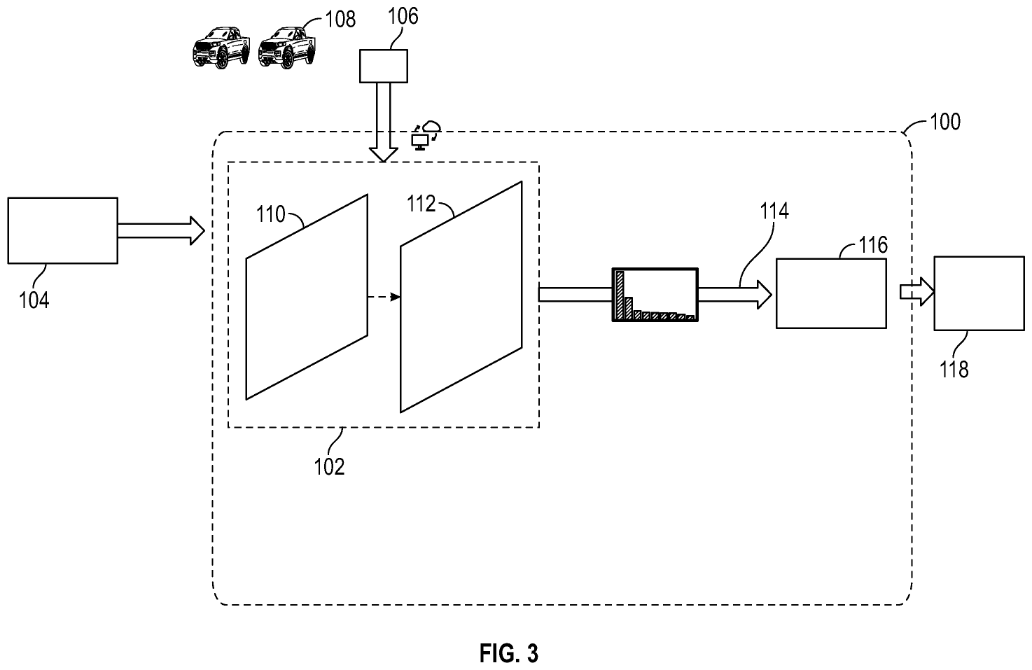

FIG. 3 depicts an embodiment of a diagnostic system 100 for identifying hidden root causes of symptoms. The diagnostic system 100 (or components thereof) are incorporated into the controller 62 or other suitable processing device(s).

A “symptom” may correspond to any received signal (or information derived from the received signal) that has an anomalous value or range of values (i.e., value(s) that do not fall within a range corresponding to normal vehicle system operation). In many cases, there may be multiple potential root causes (potential failure modes) of a symptom. The diagnostic system 100 is configured to perform a diagnostic method in order to identify the root cause (or most likely root cause) of a symptom or associated malfunction.

The diagnostic system 100 includes a signal processing module 102 configured to analyze signal data from various components or locations in a vehicle system. The signal data includes multiple signals. A “signal” refers to information from a location or component, and may take any form. For example, a signal may be a single data point or value (e.g., a fault indicator), or multiple values (e.g., a data set derived from samples taken over a selected time window). One of the signals is indicative of a malfunction or fault, and is considered a symptom of some root cause or failure mode.

For example, the system receives signals 104 (e.g., sensor data) from a vehicle system (e.g., the fuel system 18), which may include data or signals indicative of a potential malfunction or fault. The system 100 also receives additional signals or data (referred to as reference data 106) from other sources or locations (e.g., other sensors), such as controller signals (e.g., faulty and/or normal signals) received from a fleet 108 of other vehicles. The signal processing module 102 includes multiple layers of signal abstraction to identify signals or data sets that are relevant to a potential failure mode, by estimating an observability of one or more of the received signals 104 relative to the symptom.

The module 102 also selects or receives a data set or signal, referred to as a “symptom,” which indicates a fault or malfunction but does not provide enough information on its own regarding the root cause of the fault or malfunction. For example, if the controller 62 measures a low fuel pressure, there may be multiple potential root causes (e.g., a faulty controller, pump malfunction, faulty pressure sensor, etc.). The system 100 provides an effective method to identify the most likely root cause.

The symptom may be a pre-selected type of data or signal, such as a fault or failure signal, but is not so limited. In an embodiment, the system 100 allows a user to define a data set, signal or other information that is to be used as the symptom.

In an embodiment, the signal processing module 102 includes a first layer 110 in which the received signals 104 are abstracted based on their deviation from the reference data 106. Based on the comparison, a set of received signals is selected based on the level of deviation. For example, as discussed further herein, each signal 104 is analyzed to assign an anomaly index to each signal 104, and a group of signals is selected having the highest anomaly index or indexes. The signals selected by the first layer 110 are referred to as “test signals” or “test data.”

The signal processing module 102, in an embodiment, includes a number N of additional layers 112 that perform a symptom tracing method in order to identify test signals of high importance with respect to potential root causes. Such signals may be identified by estimating a level of failure mode observability of each test signal with respect to the symptom. Failure mode “observability” relates to the ability of a received signal to provide information about the actual failure mode. In another words, when a failure mode is observable from a test signal, one can use the signal to identify a possibility or probability of the failure mode. There may be multiple layers 112 (e.g., to speed up the abstraction of test signals). The signal processing module 102 outputs observability information 114 that can be used to identify a root cause of a symptom. In an embodiment, the observability information 114 includes multiple observability distributions as described further herein.

The system 100 also includes an identification module 116 configured to receive the observability information 114. The identification module 116 determines which failure mode is a root cause of the symptom based on the observability information, and outputs a detected failure mode 118, which is considered to be the most likely root cause. In an embodiment, the identification module 116 is or includes an inference engine that executes a probability analysis, but is not so limited.

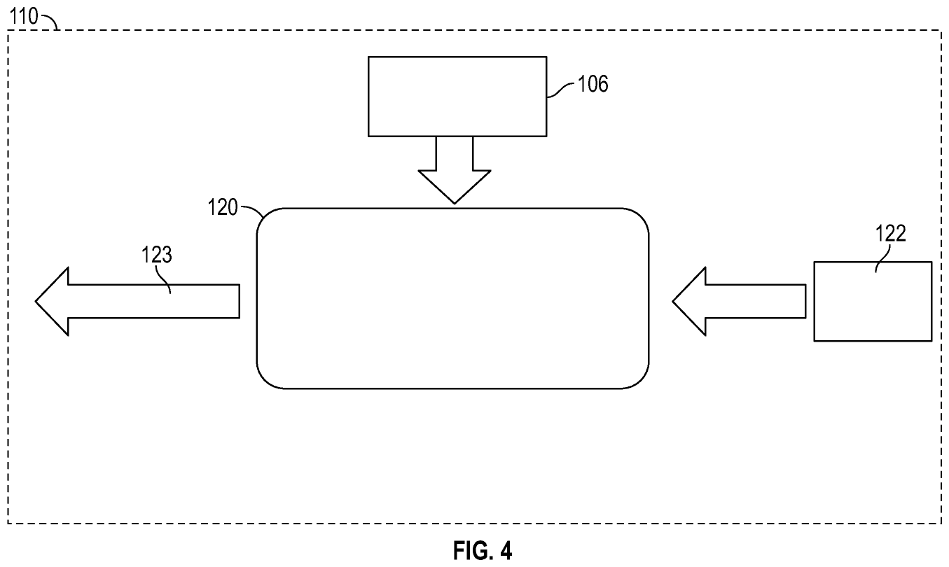

FIG. 4 depicts an embodiment of the layer 110, including an estimator 120. The estimator 120 receives reference data 106 including fleet data, which includes normal (i.e., not affected by a fault) fleet data values, such as normal sensor measurements. The reference data 106 may also include faulty fleet data, such as sensor measurements associated with faults or malfunctions in other vehicles. However, the majority of the reference data 106 are from normal (healthy) fleet. The estimator 120 compares received signals 122 (which may be part of the received signals 104) and estimates a difference between each received signal 122 and a corresponding signal or corresponding data from the reference data 106. For example, a received MAF signal from the MAF sensor 66 is compared to one or more normal MAF signals from the fleet data. Signals 122 that have higher differences may be selected to present a reduced list 123 including a subset of the received signals 122 that are potentially most relevant to some failure mode. The selected signals are referred to as test signals 124.

For example, the estimator 120 is referred to as an anomaly index estimator and calculates an anomaly index (T) for each received signal (μₓ):

$$T = \frac{( {μ}_{x} - {μ}_{fleet} )}{{σ}_{x} / \sqrt{{n}_{x}}} ,$$

where μ_{fleet} is the average value of the corresponding data from the fleet data 106, σₓ is the variance of faulty fleet data as compared to normal fleet data, and nₓ is the number of samples used in the estimation.

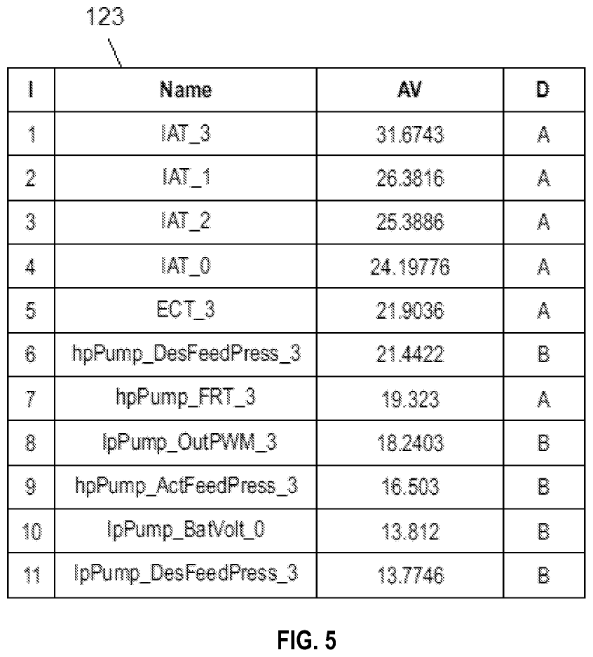

FIG. 5 depicts an example of the reduced list 123 including test signals 124. Each test signal 124 is associated with a signal index I, a signal name, and an anomaly value AV. Each anomaly value is associated with a sign or direction indicator D, where an “A” value indicates that the test signal is greater than (above) a corresponding normal value, and a “B” value indicates that the test signal is less than (below) a normal value.

In this example, the test signals 124 are related to operation of the fuel system 18, and include sensor signals indicative of conditions related to the HP pump 58 and the LP pump 54. IAT values are measurements of intake air temperature (IAT), ECT refers to engine coolant temperature (ECT) sensor measurements, hpPump_DesFeedPress refers to a desired feed pressure in the HP pump, and hpPump_ActFeedPress refers to an actual feed pressure. hpPump_FRT is fuel rail temperature (FRT) through the HP pump 58. lpPump_OutPWM is an output pulse frequency of the LP pump 54, lpPump_BatVolt is voltage applied to the LP pump, and lpPump_DesFeedPress refers to a desired feed pressure through the LP pump. Numerals at the end of each name indicate different operation conditions at which signals are collected.

The estimator 120 may output the list 123 to a user to allow the user to make their own inferences regarding the anomalous data. Alternatively, or additionally, the list 123 is output to the layer 112 for further analysis as described herein.

The user, and/or the system 100, may generate one or more hypotheses regarding the potential root causes of the symptom. An example of potential failure modes (hypotheses) is shown in the following table:

| Element Name | Fault |
|---|---|
| Err_P_{LP} (symptom) | Below average |
| P_{act, LP} | Below average |
| P_{act, HP} | Above or Equal to Average |
| ki, _{HP} | Below or Equal to Average |

In the above table, the symptom is an error message (Err_P_{LP}) received that indicates the LP pump pressure to too low. Along with the symptom, it is detected that the LP pump actual pressure (P_{act,LP}) is lower than normal, and the HP pump pressure (P_{act,Hp}) is building a pressure above the average while the HP pump's controller is applying below average effort (k_{i,HP}). The user can infer that the HP pump 58 has a different characteristic curve compared to a normal pump.

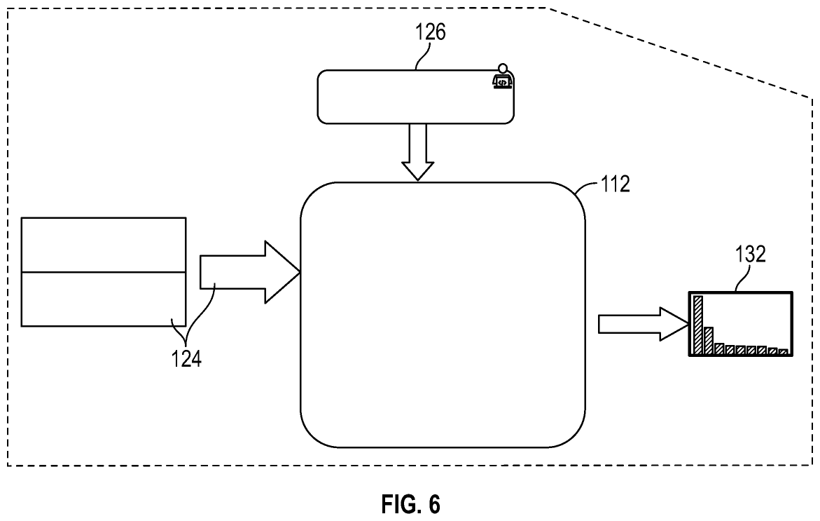

FIG. 6 depicts an embodiment of the layer 112. In this embodiment, the layer 112 receives the test signals 124, which may include the selected test signals (based on anomaly analysis) and may also include any additional data selected by the user. The layer 112 also receives labeled symptom data 126. The labeled symptom data 126 is determined by labeling a selected symptom signal using a labeling function that a user defines.

The labeled symptom data 126 is input to the layer 112, which abstracts the test signals 124 by calculating an observability index for each test signal 124, and generates an observability distribution (e.g., observability distribution 132) that includes an observability value for each test signal 124. The layer 112 (or multiple layers 112) calculates an observability distribution for each selected symptom. The observability distributions may be output to the identification module 116. Test signals with low observability value have little to no information about the failure mode and can be removed from the list 123.

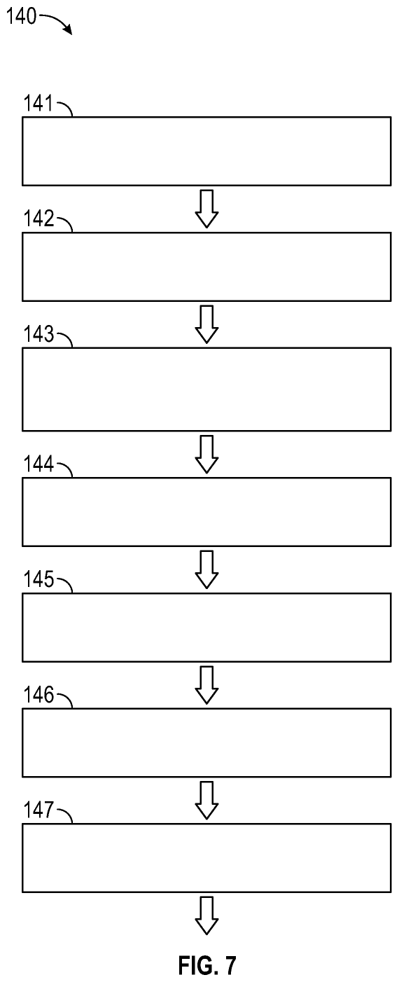

FIG. 7 is a block diagram illustrating an example of a method 140 of calculating observability indexes and distributions. The method 140 is based on an assumption that if there is a strong correlation between a symptom signal X and a test signal Z, a classifier label generated for the received signal could be duplicated using the test signal Z.

In the following, the method 140 calculates observability using a function f(X) applied to the symptom signal X. The function may be a user-defined function or otherwise acquired (e.g., determined by the system 100 or received from another source). The function f(X) is based on the observed symptom. The method 140 may be repeated for multiple different functions corresponding to different potential failure modes.

At block 141, n samples of the labeled symptom data 126 and n samples of test signals 124 are input to the layer 112. Each set of symptom data is a set of n data points xᵢ denoted [x₁ . . . xₙ], where each data point is timestamped. A classification function f(xᵢ) defined by the user is applied to each data point to generate a set of n labels yᵢ represented as [y₁ . . . yₙ]. An example of the classification function is:

$$f ( {x}_{i} ) = \{ \begin{matrix}low & if {x}_{i} < 0 \\ high & if {x}_{i} \geq 0\end{matrix}$$

At block 142, the set of labels y, is applied to a set of test data zᵢ denoted [zᵢ . . . zₙ] (i.e., a test signal). Individual labels in the symptom set are correlated via time stamps and applied to the test data z, based on the time stamps.

At block 143, signal processing is performed to select p samples from the set of test data zᵢ for each class applied by the classification function (balanced training).

At block 144, the test data samples from block 143 are used to train a classifier (e.g., a linear SVM) to classify the sampled test data.

At block 145, the trained classifier is tested by applying the trained classifier to the sampled test data, and labels are predicted. As a result, each data point from the test data zᵢ is provided a predicted label ŷᵢ including [ŷ₁ . . . ŷₙ].

The predicted labels are compared to the applied labels to determine differences therebetween. Similarity between the labels corresponds to high observability.

For example, at block 146, a deviation metric (DM) is calculated for the set of test data:

DMⱼ=Σ₁ⁿu(|i yᵢ−ŷᵢ|)/n

where DMj is the deviation metric for a given test signal j, n is the number of labels, and u is the Heaviside step function. A deviation metric includes individual deviation values {Dm₁ . . . DMₚ} for each of the p test signals.

At block 147, an observability index is calculated for each of the test

signals:

$${O}_{j} = \frac{D {M}_{j}^{- 1}}{{\sum }_{1}^{P} D {M}_{j}^{- 1}} , j = 1 , … P$$

The resulting observability index Oj includes a series of observability values [O₁ . . . Oₚ].

Blocks 142-147 are repeated for each test signal j, so that an observability distribution Dₒ is generated that includes an observability index Oj for each test signal j.

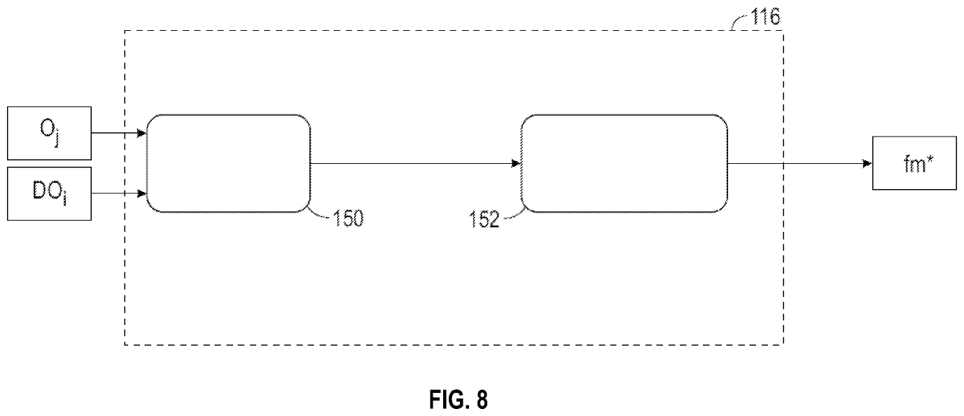

FIG. 8 depicts an embodiment of the identification module 116. The identification module receives P observability indices from 147. For each potential failure mode fmᵢ, a known (a priori) observability distribution Doᵢ is also input. Thus, the identification module 116 receives the name and data of selected symptom signals, observability distributions for potential failure modes and the set of observability indices [O₁, O₂, O₃ . . . ].

The symptom, observability distributions for a priori known failure modes and observability indices (from block 147) for a set of test signals are input to an inference module 150 or inference engine, which calculates a set of conditional probabilities for all potential failure modes. The conditional probability for a failure mode fmᵢ, given the set of observability distributions, is denoted as P(fmᵢ|O₁, O₂, O₃, . . . Oₚ). The conditional probability for each failure mode fmᵢ may be calculated using the following formula:

$$P ( {fm}_{i} \vert {O}_{1} , … , {O}_{p} ) = \frac{P ( {O}_{1} , … , {O}_{p} \vert {fm}_{i} ) * P ( {fm}_{i} )}{P ( {O}_{1} , … , {O}_{p} )} ,$$

where P(O₁, . . . Oₚ|fmᵢ) is the conditional probability for the failure mode fmᵢ. P(fmᵢ) is the prior probability of the failure mode occurring, and P(O₁, O₂, . . . ) is the probability of the set of observability distributions. In an embodiment, a uniform prior probability is assumed for all tested failure modes, that is P (fmᵢ)=1/N where N is the number of failure modes being tested.

The conditional probabilities of each candidate failure mode are input to a module 152 for determining the failure mode that is most likely to represent the root cause. The failure mode with the highest probability (maximum posteriori probability) is denoted as fm*, and is output to a user as the most likely root cause of the symptom.

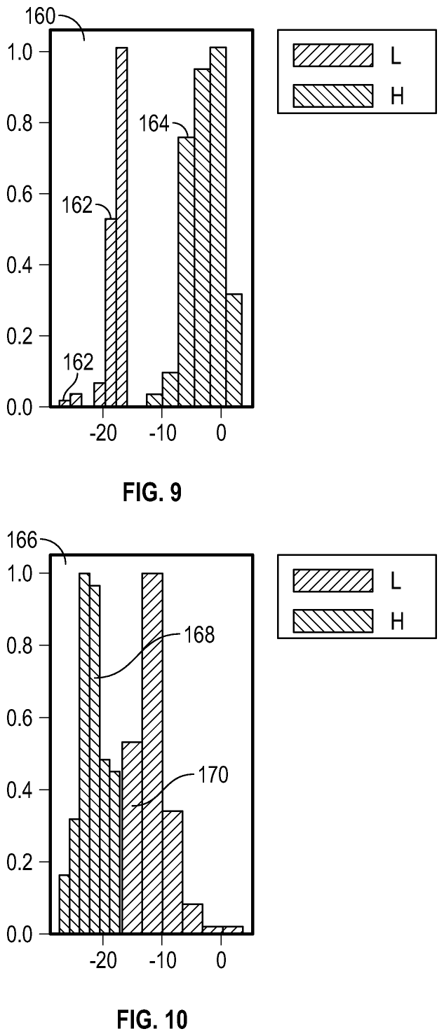

FIGS. 9-15 represent an example of a diagnostic method performed by the system 100. In this example, the symptom is a low long term multiplier (LTM) calculated by the controller 56. Other symptoms may be selected as desired, such as misfire count, RPM, IAT, ECT and others.

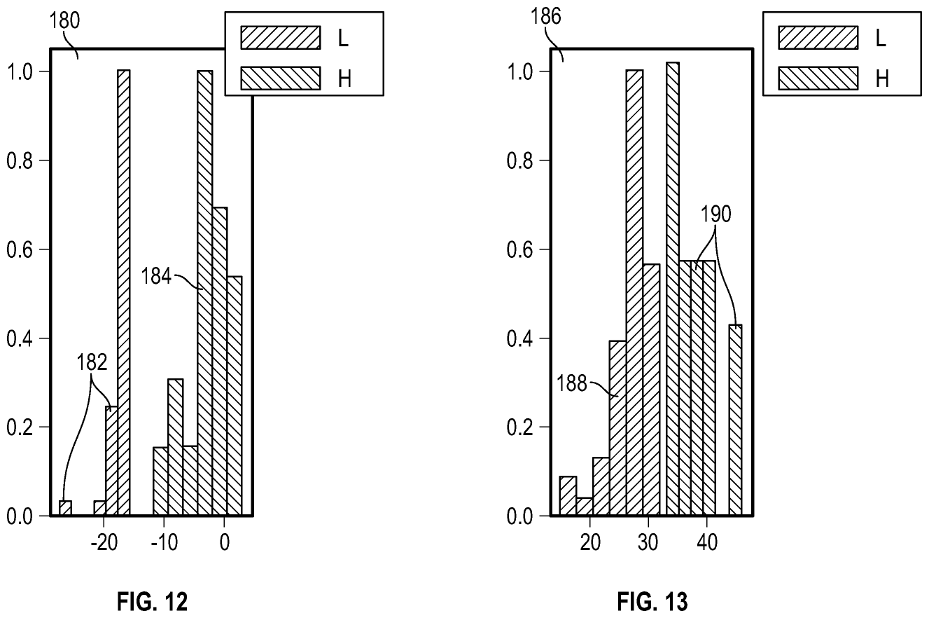

In this example, two potential failure modes are discussed, although this example may include consideration of additional potential failure modes. Referring to FIGS. 9-11, a first potential failure mode has an observability distribution for a set of test signals. Referring to FIGS. 12-14, a second potential failure mode has a different observability distribution for the set of test signals.

The system 100 receives symptom data in the form of LTM values calculated for a series of timestamped samples. The LTM is normally 1, but in this example, the LTM is low, indicating that the air/fuel mixture is too rich.

The system 100 also receives the set of test signals that include a MAF sensor correction signal during driving (MAF_Corr_cruise) and during idle (MAF_Corr_cruise), air/fuel ratio (AFR_imb), and total misfire count (Tot_Misfire). Other test signals include average air per cyclinder (APC), average RPM (Avg_RPM), IAT measured at maximum or minimum of LTM value (IAT_atLTM) and ECT (ECT_atLTM), and odometer readings (odm_read).

For the first potential failure mode, the LTM values are labeled (e.g., at block 141) using a function that classifies LTM values according to classes that include a “high” or “H” class and a “low” or “L” class. FIG. 9 depicts an example of labels 160 generated for the LTM symptom data. Low values for this failure mode are represented by bars 162, and high values are represented by bars 164. The LTM values are classified using a function that defines a threshold for low LTM values corresponding to insufficient air flow, and a threshold for high LTM values corresponding to excessive airflow.

FIG. 10 shows labels 166 for the MAF_Corr_cruise test signal, after the trained classifier is used (e.g., at block 145) to label samples in the set of test data. High values are represented by bars 168, and low values are represented by bars 170. Correlating the classes (i.e., Low and High) of FIG. 10 with the classes of FIG. 9, one can observe that when low LTM values (e.g., LTM<−15) are measured, high MAF values are observed (e.g., MAF>1.1). An observability index was derived according to the method 140.

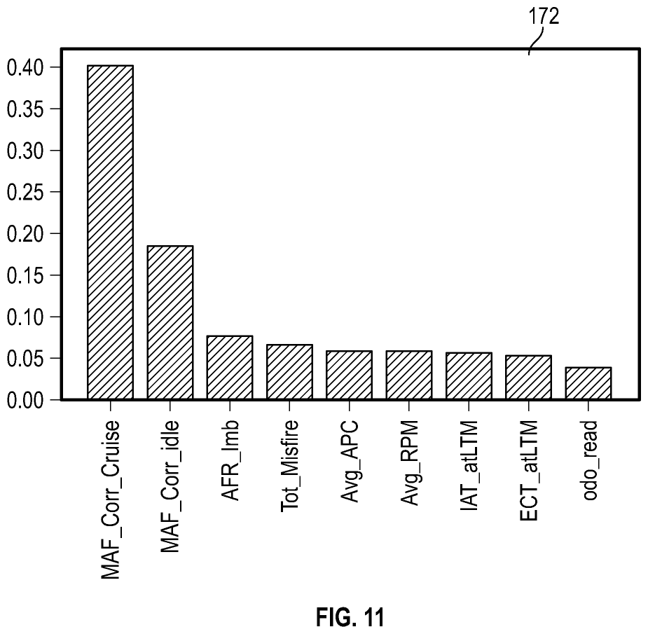

The labeled LTM data (labels 160) was used to calculate observability indexes for the remaining test signals. The results are shown in FIG. 11 as an observability distribution 172 for the first potential failure mode.

For the second potential failure mode, the LTM values are labeled (e.g., at block 141) for a new data set and using a function that classifies LTM values according to classes that include high and low classes. FIG. 12 depicts an example of a labeled LTM data, shown as labels 180, generated for the LTM symptom data. Low values for this failure mode are represented by bars 182, and high values are represented by bars 184. The LTM values are classified using a function that defines a threshold for low LTM values and a threshold for high LTM values based on air temperature.

FIG. 13 shows test data labels 186 for the IAT_atLTM test signal, which was generated after the trained classifier is used (e.g., at block 145) to label samples in the set of test signals. Low values are represented by bars 188, and high values are represented by bars 190. Another observability index was derived according to the method 140.

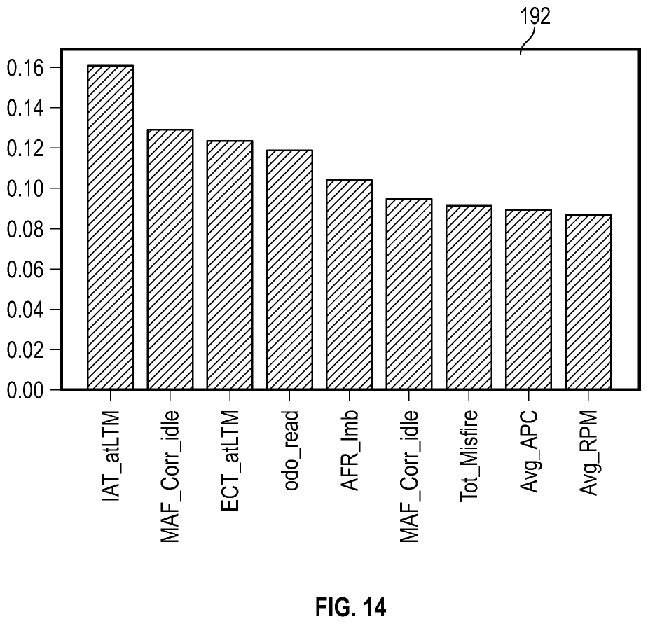

The labeled LTM data was used to calculate observability indexes for the remaining test signals. The results for the second potential failure mode are shown as an observability distribution 192 in FIG. 14. The observability distributions 172 and 192 (and any additional distributions calculated) can be input to the identification module 116 to determine which failure mode is most likely, and thus considered a root cause.

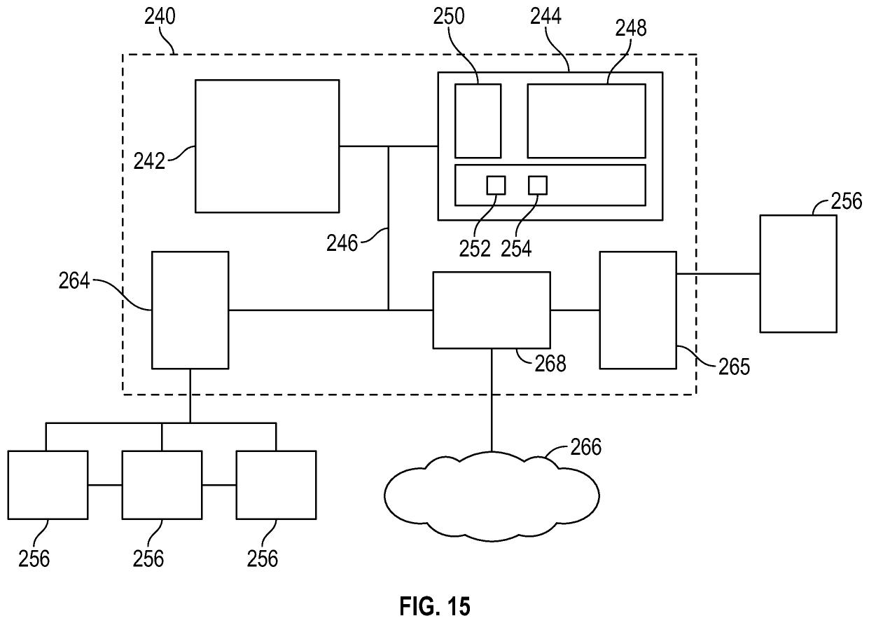

FIG. 15 illustrates aspects of an embodiment of a computer system 240 that can perform various aspects of embodiments described herein. The computer system 240 includes at least one processing device 242, which generally includes one or more processors for performing aspects of image acquisition and analysis methods described herein.

Components of the computer system 240 include the processing device 242 (such as one or more processors or processing units), a memory 244, and a bus 246 that couples various system components including the system memory 244 to the processing device 242. The system memory 244 can be a non-transitory computer-readable medium, and may include a variety of computer system readable media. Such media can be any available media that is accessible by the processing device 242, and includes both volatile and non-volatile media, and removable and non-removable media.

For example, the system memory 244 includes a non-volatile memory 248 such as a hard drive, and may also include a volatile memory 250, such as random access memory (RAM) and/or cache memory. The computer system 240 can further include other removable/non-removable, volatile/non-volatile computer system storage media.

The system memory 244 can include at least one program product having a set (i.e., at least one) of program modules that are configured to carry out functions of the embodiments described herein. For example, the system memory 244 stores various program modules that generally carry out the functions and/or methodologies of embodiments described herein. A module 252 may be included for performing functions related to acquiring signals and data, and a module 254 may be included to perform functions related to diagnostics as discussed herein. The system 240 is not so limited, as other modules may be included. As used herein, the term “module” refers to processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality.

The processing device 242 can also communicate with one or more external devices 256 as a keyboard, a pointing device, and/or any devices (e.g., network card, modem, etc.) that enable the processing device 242 to communicate with one or more other computing devices. Communication with various devices can occur via Input/Output (I/O) interfaces 264 and 265.

The processing device 242 may also communicate with one or more networks 266 such as a local area network (LAN), a general wide area network (WAN), a bus network and/or a public network (e.g., the Internet) via a network adapter 268. It should be understood that although not shown, other hardware and/or software components may be used in conjunction with the computer system 40. Examples include, but are not limited to: microcode, device drivers, redundant processing units, external disk drive arrays, RAID systems, and data archival storage systems, etc.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A method of diagnosing a malfunction, comprising:
receiving a signal from a component of a vehicle system, the received signal indicative of a symptom of a malfunction in the vehicle system;
acquiring a set of test signals;
comparing the received signal to each test signal to determine at least one observability distribution, the observability distribution including an observability value for each test signal; and
determining a failure mode corresponding to the received signal based on the observability distribution, the determined failure mode representing a root cause of the symptom.

2. The method of claim 1, wherein each test signal is acquired from one or more components that are different than the component associated with the received signal.

3. The method of claim 1, wherein the comparing includes determining a plurality of observability distributions.

4. The method of claim 3, wherein an observability distribution is determined by:
applying a classification function to the received signal, and generating a first label for the received signal;
applying the first label to each test signal to generate labeled test signals, the first label classifying each test signal into one of a plurality of classes;
training a classifier using selected data from each class;
generating a predicted label for each test signal by applying the trained classifier to each test signal; and
calculating an observability value for each test signal based on a comparison of the first labels to the predicted labels.

5. The method of claim 4, wherein calculating the observability value includes calculating a deviation metric based on the comparison.

6. The method of claim 3, wherein determining the failure mode includes inputting the received signal and the observability distributions to an inference algorithm, and estimating a probability of each observability distribution corresponding to the root cause.

7. The method of claim 6, wherein determining the failure mode includes selecting a potential failure mode associated with an observability distribution having a highest probability as the root cause.

8. The method of claim 6, wherein the inference algorithm includes a Bayesian classifier.

9. The method of claim 1, wherein acquiring the set of test signals includes acquiring a plurality of additional signals in addition to the received signal, comparing each additional signal to fleet data indicative of normal vehicle system function, determining an anomaly index for each additional signal, and selecting the set of test signals from the plurality of additional signals based on the anomaly indexes.

10. A system for diagnosing a malfunction, comprising:
a signal processing module configured to:
receive a signal from a component of a vehicle system, the received signal indicative of a symptom of a malfunction in the vehicle system;
acquire a set of test signals; and
compare the received signal to each test signal to determine at least one observability distribution, the observability distribution including an observability value for each test signal; and
an identification module configured to determine a failure mode corresponding to the received signal based on the observability distribution, the determined failure mode representing a root cause of the symptom.

11. The system of claim 10, wherein the signal processing module is configured to determine a plurality of observability distributions, and output the received signal and the plurality of the observability distributions to the identification module.

12. The system of claim 11, wherein an observability distribution is determined by:
applying a classification function to the received signal, and generating a first label for the received signal;
applying the first label to each test signal to generate labeled test signals, the first label classifying each test signal into one of a plurality of classes;
training a classifier using selected data from each class;
generating a predicted label for each test signal by applying the trained classifier to each test signal; and
calculating an observability value for each test signal based on a comparison of the first labels to the predicted labels.

13. The system of claim 11, wherein the identification module includes an inference algorithm configured to estimate a probability of each observability distribution corresponding to the root cause.

14. The system of claim 13, wherein the identification module is configured to determine the failure mode by selecting a potential failure mode associated with an observability distribution having a highest probability as the root cause.

15. The system of claim 10, wherein the signal processing module includes a multi-layer architecture including a first layer configured to acquire the set of test signals, and a second layer configured to determine the at least one observability distribution.

16. The system of claim 15, wherein the first layer is configured to receive a plurality of additional signals in addition to the received signal, compare each additional signal to fleet data indicative of normal vehicle system function, determine an anomaly index for each additional signal, and select the set of test signals from the plurality of additional signals based on the anomaly indexes.

17. A vehicle system comprising:
a memory having computer readable instructions; and
a processing device for executing the computer readable instructions, the computer readable instructions controlling the processing device to perform a method including:
receiving a signal from a component of a vehicle system, the received signal indicative of a symptom of a malfunction in the vehicle system;
acquiring a set of test signals;
comparing the received signal to each test signal to determine at least one observability distribution, the observability distribution including an observability value for each test signal; and
determining a failure mode corresponding to the received signal based on the observability distribution, the determined failure mode representing a root cause of the symptom.

18. The vehicle system of claim 17, wherein the comparing includes determining a plurality of observability distributions.

19. The vehicle system of claim 18, wherein an observability distribution is determined by:
applying a classification function to the received signal, and generating a first label for the received signal;
applying the first label to each test signal to generate labeled test signals, the first label classifying each test signal into one of a plurality of classes;
training a classifier using selected data from each class;
generating a predicted label for each test signal by applying the trained classifier to each test signal; and
calculating an observability value for each test signal based on a comparison of the first labels to the predicted labels.

20. The vehicle system of claim 18, wherein determining the failure mode includes inputting the received signal and the observability distributions to an inference algorithm, estimating a probability of each observability distribution corresponding to the root cause, and selecting a potential failure mode associated with an observability distribution having a highest probability as the root cause.
